(19) United States
(12) Patent Application Publication
(10) Pub. No.: US 2025/0328015 A1
(43) Pub. Date: Oct. 23, 2025

(54) REFLECTIVE WAVEGUIDE PUPIL REPLICATOR

(71) Applicant: GOOGLE LLC, Mountain View, CA (US)

(72) Inventors: Eliezer Glik, San Diego, CA (US); Ozan Cakmakci, San Bruno, CA (US); Oscar Alberto Martinez, San Diego, CA (US); Christophe Peroz, Zollikon (CH)

(21) Appl. No.: 18/641,293

(22) Filed: Apr. 19, 2024

Related U.S. Application Data
(60) Provisional application No. 63/460,685, filed on Apr. 20, 2023.

(51) Int. Cl. G02B 27/01; G02B 6/42

(52) U.S. Cl. CPC G02B 27/0172; G02B 6/42; G02B 6/4214

(57) ABSTRACT

An optical component includes a reflective waveguide with a first transparent body made of polymer, incorporating one or more facets, and a second transparent body also made of polymer. A thin film layer is partially positioned at the facets of the first transparent body, with the first surface of the first transparent body aligned with the second surface of the second transparent body. Additionally, one or more pupil replicators, featuring a substantially planar surface, are integrated into a first portion of the facets. This configuration enhances optical performance and facilitates efficient light manipulation within the waveguide, offering improved functionality and versatility in various optical applications.

### BACKGROUND

Achieving uniformity and efficiency in reflective waveguides poses many challenges, typically due to the complex interplay between total thickness, bounce spacing, and input pupil size. The inherent trade-off between these parameters complicates efforts to maintain uniformity. Manufacturing constraints frequently dictate the thickness for reflective waveguides, yet maintaining adequate pupil overlap during light extraction poses a persistent issue, typically with constant input pupil sizes. This dilemma can result in undesired gaps and/or holes in the eyebox. In the context of reflective waveguides, which are commonly used in augmented reality (AR) or mixed reality (MR) displays, the phenomenon of holes in the eyebox often arises from challenges in achieving uniformity and efficiency in light propagation. When light enters the waveguide, the light undergoes multiple internal reflections before exiting and reaching the user's eyes. However, if the size and distribution of the input pupil (the entrance aperture for light) are not adequately matched with the optical properties of the waveguide, certain areas within the display field may receive insufficient or distorted light, leading to perceptible gaps and/or holes in the visual content. As a result, these holes in the eyebox can degrade the user experience, causing discontinuities or distortions in the augmented content and impairing the immersion and effectiveness of the AR/MR display. Therefore, addressing and minimizing these gaps through advanced optical design and manufacturing techniques may enhance the quality and usability of immersive display technologies.

When considering pupil overlap systems inserted into unused portions of a waveguide, a disruption of the desired layout may occur and lead to several undesirable issues. These issues can include optical interference, as the pupil overlap system may interfere with the intended path of light, resulting in reduced image quality. Additionally, spatial constraints arise, limiting available space for other optical components and making it challenging to achieve the desired configuration. Alignment becomes a factor, as any misalignment of the pupil overlap system can lead to misdirected light and uneven illumination. Manufacturing complexity increases due to the added intricacies of integrating the pupil overlap system, raising production costs and potential challenges. Moreover, there may be light loss introduced into the system, impacting overall brightness and contrast. Lastly, heat dissipation becomes a concern if the pupil overlap system generates heat, potentially leading to overheating and decreased reliability of the waveguide.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a diagram of a waveguide with an input coupler (IC) aligned with an exit pupil expander (EPE) with light configured to traverse the IC toward the output coupler (OC) direction that may be implemented with one or more reflective pupil replicators in accordance with some embodiments.

FIG. 2 is a cross-sectional view of an example of a reflective pupil replicator implemented at a substantially planar surface of a proximal end of one or more facets of the waveguide of FIG. 1 in accordance with some embodiments.

FIG. 3 is a cross-sectional view of an example of one or more reflective pupil replicators implemented at a substantially planar surface of a proximal end and a distal end of one or more facets of the waveguide of FIGS. 1 and 2 in accordance with some embodiments.

FIG. 4 is a cross-sectional view of an example of a reflective pupil replicator implemented at a substantially planar surface of a proximal end of two or more facets of the waveguide of FIGS. 1 and 2 with a varied length of the substantially planar surface at subsequent facets of the two or more facets in accordance with some embodiments.

FIG. 5 is a diagram illustrating a rear perspective view of the set of AR glasses implementing the one or more reflective pupil replicator structures of FIGS. 1-4 in accordance with some embodiments.

FIG. 6 is a diagram illustrating a method for forming a reflective waveguide of FIGS. 1-4 with pupil replicator structures implemented in the set of AR glasses of FIG. 5 in accordance with some embodiments.

### DETAILED DESCRIPTION

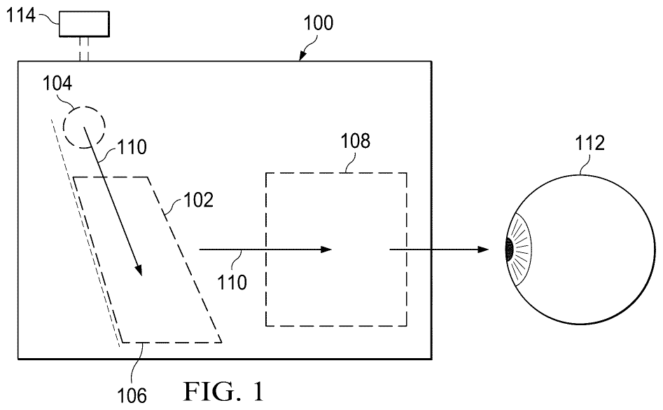

FIGS. 1-6 illustrate example configurations, structures, and processes to implement a pupil replicator at one or more facets in a reflective waveguide in a head-mounted wearable device (HMWD), such as a set of smart glasses, augmented reality (AR), and/or virtual reality (VR) glasses. The reflective waveguide may include a first transparent body composed of, for example, a polymer. One or more facets may be implemented at least partially in the first transparent body. A thin film layer may be partially disposed at the one or more facets of the first transparent body. A second transparent body may be composed of the same material. A first surface of the first transparent body may be disposed at a second surface of the second transparent body. One or more pupil replicators may be composed of a substantially planar surface implemented at a first portion of the one or more facets to result in a higher reflection coefficient on the surface of the pupil replicator. Within reflective waveguides, this higher reflection coefficient enables more efficient duplication of the input pupil's image as it undergoes total internal reflection (TIR) within the waveguide. For example, a greater proportion of the incoming light is redirected towards the replication process, resulting in a more accurate and complete reproduction of the pupil's image at the waveguide's exit.

However, while higher reflection facilitates improved replication, it also introduces the risk of see-through artifacts. These artifacts occur when a portion of the replicated pupil's image is not fully attenuated or diffused upon exiting the waveguide, resulting in unintended transparency or ghosting effects in the displayed content. The increased reflection coefficient often enhances the likelihood of residual light from the replicated pupils escaping the waveguide, causing interference with the desired visual content. To address this challenge, an integrally formed pupil replicator is introduced to facilitate pupil replication TIR within the waveguide. Positioned approximately at the center of the waveguide and parallel to its surfaces, the pupil replicator aims to enhance pupil overlap as light exits the waveguide, thereby mitigating gaps in the eyebox. Typically, the pupil replicator is coated with a partially reflective material to optimize its performance. Therefore, achieving a balance between reflection efficiency and the suppression of see-through artifacts is considered in the design and implementation of the pupil replication system within a reflective waveguide. Moreover, the integration of the pupil replicator within one or more facets of the waveguide of FIG. 1 in the HMWD involves careful selection of materials and coatings for the pupil replicator, as well as fine-tuning of the reflection properties to mitigate undesirable visual effects while maximizing the fidelity of pupil duplication.

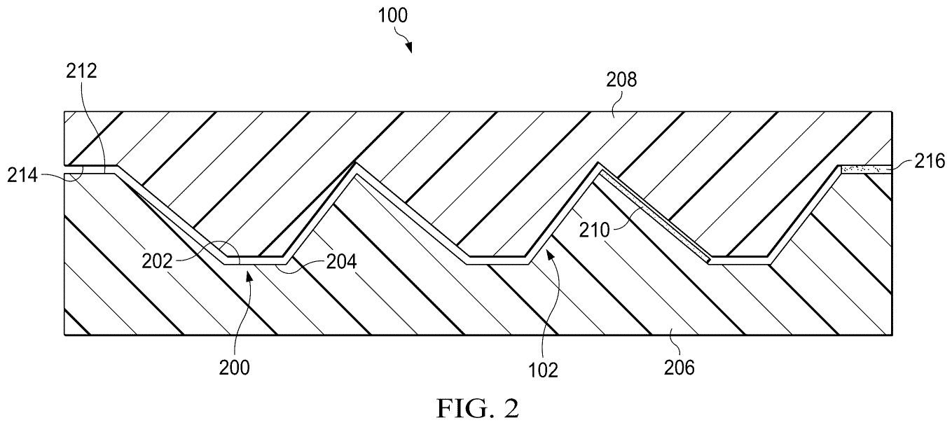

FIG. 1 illustrates an example waveguide 100 for use in a HMWD that implements one or more pupil replicators at a portion of the one or more facets 102 in accordance with some embodiments. The one or more facets 102 may be at least partially in alignment with one or more optical components such as at least one of an EPE 106 or an output coupler (OC) 108. The illustrated waveguide 100 may be, for example, utilized in conjunction with a light engine 114 to facilitate light propagation within the waveguide 100. The waveguide 100, in some implementations, includes an input coupler (IC) 104, an exit pupil expander (EPE) 106, and/or an OC 108. An entrance pupil of the IC 104 is configured to receive display light 110 from the exit pupil of the light engine 114 and/or another light source. In implementations that include an EPE 106, the EPE 106 is configured to increase the size of the display exit pupil. The position of the IC 104 typically is tied to the position of the EPE 106; that is, the IC 104 is aligned with EPE 106. In other words, they are adjusted and aligned in a way that facilitates the smooth transition of light from one component to the other. The OC 108 is configured to direct the resulting display light 110 toward a user's eye 112. This combination of components operates together for the display light to reach the user's eye in the intended manner. Although a pupil replicator may be implemented at a first portion of one or more facets 102 of the waveguide 100, the waveguide 100 employs an example of a first portion of the one or more facets 102 being a proximal end of the one or more facets 102, as shown in FIG. 2

FIG. 2 illustrates the waveguide 100 of FIG. 1 that implements an example structure for a pupil replicator 200 in accordance with some embodiments. The pupil replicator 200 may be composed of a substantially planar surface 202 implemented at a first portion 204 of the one or more facets 102. The first portion 204 of the one or more facets 102 is a proximal end of the one or more facets. The waveguide includes a first transparent body 206 composed of a polymer or other material. The one or more facets 102 may be implemented at least partially in the first transparent body 206. A second transparent body 208 may be composed of the same material (e.g., the same polymer) or a different material. A thin film layer 210 is partially disposed at the one or more facets 102 of the first transparent body 206. The thin film layer 210 may include an optical coating that may be a partially reflective coating disposed on one or more facets 102. A first surface 212 of the first transparent body 206 is disposed at a second surface 214 of the second transparent body 208. An adhesive 216 may be disposed at an interface between the first surface of the first transparent body 206 and the second surface of the second transparent body 208 to bond the two transparent bodies 206, 208 together.

In implementations, any of a variety of materials may be suitable for use as the optical coating that may serve as a partially or semi-reflective coating on one or more facets 102. Among these materials, dielectric compounds such as titanium dioxide (TiO2), silicon dioxide (SiO2), tantalum oxide (Ta2O5), and hafnium oxide (HfO2) may be utilized. Additionally, metallic coatings involving aluminum (Al) or silver (Ag) may also be employed for their reflective properties. A plurality of optical coatings may be utilized in multiple layers of these materials to achieve reflectivity, durability, and optical performance in a waveguide for AR displays.

As noted, in at least one embodiment, in a faceted waveguide, the design may incorporate faceted structures within both transparent bodies of the waveguide. These faceted structures serve at least two purposes: first, they provide a medium for the precise deposition of partially reflective coatings onto their surfaces, and second, they facilitate efficient light guidance within the waveguide. Each faceted structure may be composed from materials with the same refractive indices to the surrounding medium, ensuring seamless integration into the waveguide's overall optical path. These materials may be selected to optimize the performance of the waveguide to balance factors such as refractive index, transparency, and mechanical stability. After the fabrication of the faceted structures, the two transparent bodies of the waveguide may be joined together using an index matching adhesive 216. Typically, this adhesive 216 may be formulated or selected to have a refractive index that matches that of the surrounding materials, rendering the faceted structures substantially undetectable during light transmission. This bonding process maintains the optical integrity of the waveguide, as any mismatch in refractive indices may lead to unwanted reflections and/or scattering, degrading the performance of the device. In this combination, the reflective waveguide achieves the dual objectives of efficient light guidance and controlled reflection, making it an indispensable component in various optical systems and applications.

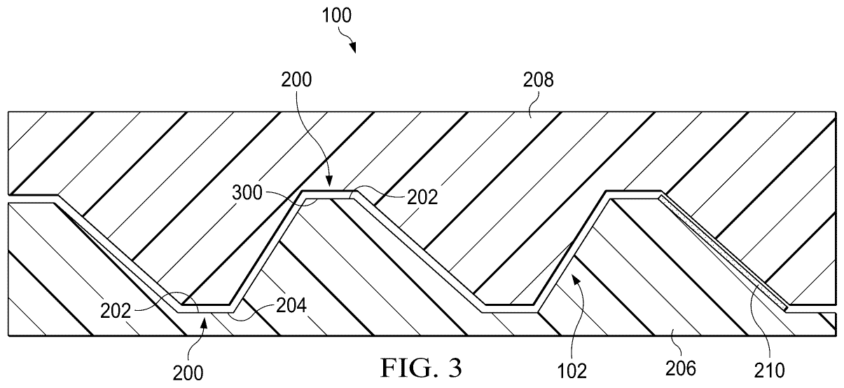

Further, in implementations, the proximal end of the one or more facets 102 refers to the end of the facet that is nearest to the source or point of entry of light into the waveguide 100. For example, if the waveguide 100 with the one or more facets 102 that guide light from an external source into the waveguide 100, the portion of the one or more facets 102 closest to where the light enters would be considered the proximal end. This proximal end serves as the initial point of interaction for the incoming light, before it undergoes reflection or propagation within the waveguide. The pupil replicator 200 may be composed of the substantially planar surface implemented at a second portion of the one or more facets 102 as shown in FIG. 3.

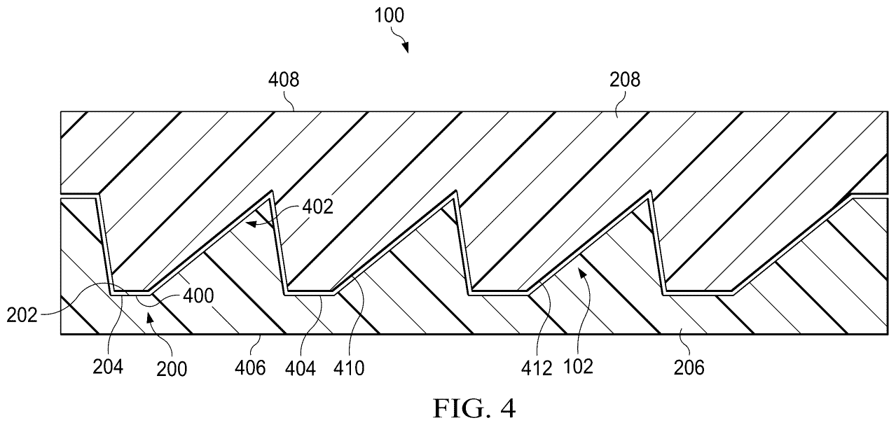

FIG. 3 illustrates an implementation of the waveguide 100 of FIGS. 1 and 2 that incorporates an example structure for one or more pupil replicators 200 in accordance with some embodiments. In an example, one or more pupil replicators 200 are implemented at a substantially planar surface 202 of a first portion 204 being the proximal end of one or more facets 102 of the waveguide 100 and a second portion 300 being a distal end of one or more facets 102 of the waveguide 100. A thin film layer 210 is partially disposed at the one or more facets 102 of the first transparent body 206 or the second transparent body 208. Although the one or more pupil replicators 200 may be implemented at a portion of one or more facets 102 of the waveguide 100, the waveguide 100 employs an example of the varied length of the substantially planar surface at two or more substantially planar surfaces as shown in FIG. 4.

FIG. 4 illustrates an embodiment of the waveguide 100 of FIGS. 1-3 that incorporates an example structure for one or more pupil replicators 200 in accordance with some embodiments. In an example, the one or more pupil replicators 200 are implemented by varying a length of two or more adjacent substantially planar surfaces 202. In an embodiment, the substantially planar surface 202 may have a length that gradually increases or decreases in size at one or more successive facets along a portion of the length of waveguide 100. The pupil replicator's length can vary within its structure, offering flexibility to enhance uniformity or performance. For example, one side of a facet may feature a first substantially planar surface of a certain length, while the other side may have a second substantially planar surface of a different length. This variation in length allows for optimization without compromising the overall effectiveness of the system. In an embodiment, a first substantially planar surface 400 is located on a first side of a facet 402 and may have a length either greater than or less than (not shown) a successive second substantially planar surface 404 located on a second side of the facet 402. The substantially planar surface 202 of the one or more pupil replicators 200 is parallel to a third surface 406 of the first transparent body 206. The substantially planar surface 202 of the one or more pupil replicators 200 is parallel to a fourth surface 408 of the second transparent body 208. In another embodiment, a first facet 410 of the one or more facets is oriented parallel to a second facet 412 of the one or more facets 102.

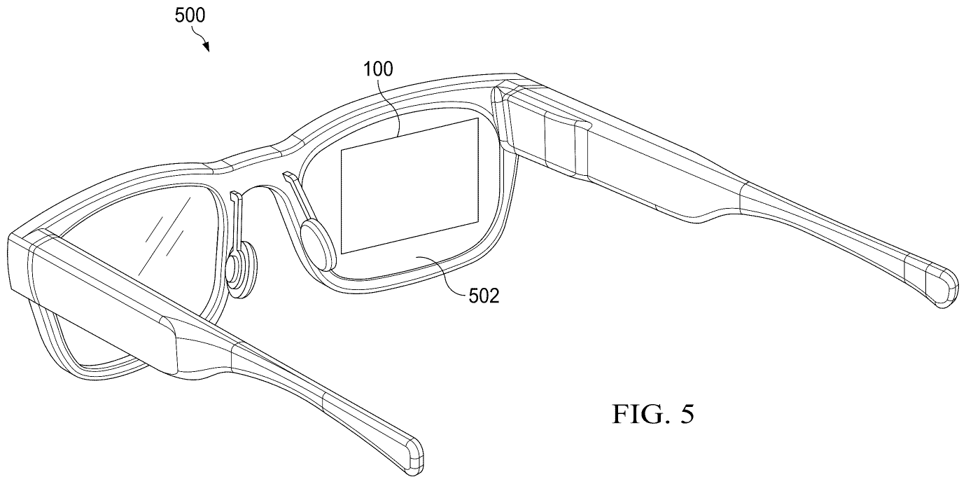

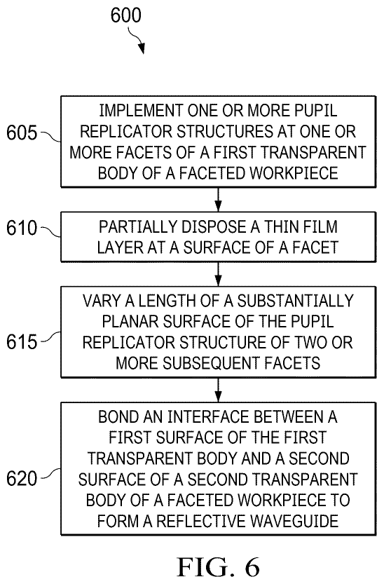

FIG. 5 illustrates a HWMD (in the form of a set of AR glasses 500) implementing the waveguide 100 of FIG. 1 with various embodiments of pupil replicator structures as described in FIGS. 2-4. As shown, the AR glasses 500 include a set of lenses, including a lens 502 incorporating the waveguide 100. In particular, reflective waveguides implemented in a set of AR glasses, the placement of pupil replicating surfaces can be positioned on either or both sides of the peak/valley structure to optimize luminance uniformity. This positioning flexibility allows for precise adjustment to achieve desired optical performance characteristics. In certain scenarios, the pupil replicator may be aligned parallel to the top and bottom surfaces of the waveguide, ensuring optimal alignment with the incident light path. Additionally, the utilization of multiple replicators is feasible, further enhancing the customization and adaptability of the optical system The process of creating the waveguide 100 involves several steps as shown in FIG. 6.

FIG. 6 illustrates a method 600 for forming the reflective waveguide of FIGS. 1-4 with the pupil replicator structures implemented in the set of AR glasses of FIG. 5 in accordance with some embodiments. At block 605, the one or more pupil replicator structures include a substantially planar surface and are implemented at one or more facets of a first transparent body of a faceted workpiece. In an embodiment, the one or more optical components may be implemented at least partially in alignment with the one or more facets of the faceted workpiece. The one or more optical components may include at least one of an EPE or an OC. The one or more pupil replicators are composed of a substantially planar surface at a first portion of one or more facets of a first transparent body of a faceted workpiece. The first portion of the one or more facets is a proximal end of the one or more facets. In an embodiment, the one or more pupil replicators are composed of a substantially planar surface at a second portion of one or more facets of a first transparent body of a faceted workpiece. The second portion of the one or more facets is a distal end of the one or more facets.

At block 610, a thin film layer is disposed between the substantially planar surface of the first portion of the one or more facets and a second portion of the one or more facets. In an embodiment, the thin film layer may be partially disposed at a surface of a facet such as at the substantially planar surface of the proximal end, the distal end, and/or between the proximal end and the distal end of one or more facets. The thin film layer includes a semi-reflective material. In one embodiment, a comprehensive approach involves the application of a blanket partially reflective coating across the entire waveguide surface. This differs from a configuration where masking is imperative to avoid coating the unmasked facet, as unintentional coating of this facet could lead to undesirable artifacts in the output, in some embodiments. To mitigate this risk, distinct coatings can be employed for the pupil replicator and the partial reflector facet, each tailored to fulfill specific optical requirements. Furthermore, variations in coating formulations for the top and bottom surfaces of the pupil replicator offer additional flexibility in optimizing optical properties. These coatings can be applied through masking techniques and executed in separate coating processes to ensure precision and consistency. Alternative manufacturing methodologies may also be explored to achieve the desired optical outcomes efficiently and effectively. At block 615, the one or more pupil replicators may be implemented by varying a length of the substantially planar surface of the pupil replicator of two or more subsequent facets of the one or more facets. At block 620, an interface between a first surface of the first transparent body and a second surface of a second transparent body is bonded with an adhesive.

In some embodiments, certain aspects of the techniques described above may be implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A reflective waveguide comprising:
a first transparent body;
one or more facets implemented at least partially in the first transparent body;
a second transparent body;
a thin film layer partially disposed at the one or more facets of the first transparent body;
a first surface of the first transparent body disposed at a second surface of the second transparent body; and
one or more pupil replicators, each pupil replicator composed of a substantially planar surface implemented at a first portion of the one or more facets.

2. The reflective waveguide of claim 1, wherein the first portion of the one or more facets is a proximal end of the one or more facets.

3. The reflective waveguide of claim 1, wherein the one or more pupil replicators are composed of the substantially planar surface implemented at a second portion of the one or more facets.

4. The reflective waveguide of claim 3, wherein the second portion of the one or more facets is a distal end of the one or more facets.

5. The reflective waveguide of claim 1, further comprising:
one or more optical components implemented at least partially in alignment with the one or more facets.

6. The reflective waveguide of claim 5, wherein the one or more optical components comprise at least one of an exit pupil expander or an output coupler.

7. The reflective waveguide of claim 1, wherein the thin film layer includes a semi-reflective material.

8. The reflective waveguide of claim 1, wherein the one or more pupil replicators are implemented by varying a length of the substantially planar surface at two or more substantially planar surfaces.

9. The reflective waveguide of claim 1, further comprising:
an adhesive disposed at an interface between the first surface of the first transparent body and the second surface of the second transparent body.

10. The reflective waveguide of claim 1, wherein the substantially planar surface of the one or more pupil replicators is parallel to a third surface of the first transparent body.

11. The reflective waveguide of claim 10, wherein the substantially planar surface of the one or more pupil replicators is parallel to a fourth surface of the second transparent body.

12. A head mounted wearable device implementing the reflective waveguide of claim 1.

13. A method for forming a reflective waveguide comprising:
implementing one or more pupil replicators composed of a substantially planar surface at a first portion of one or more facets of a first transparent body of a faceted workpiece;
disposing a thin film layer between the substantially planar surface of the first portion of the one or more facets and a second portion of the one or more facets; and
bonding an interface between a first surface of the first transparent body and a second surface of a second transparent body.

14. The method of claim 13, wherein the first portion of the one or more facets is a proximal end of the one or more facets.

15. The method of claim 14, further comprising:
disposing the thin film layer at the substantially planar surface of the proximal end of one or more facets, and wherein the thin film layer includes a semi-reflective material.

16. The method of claim 13, further comprising:
implementing the one or more pupil replicators composed of a substantially planar surface at a second portion of one or more facets of a first transparent body of a faceted workpiece, and wherein the second portion of the one or more facets is a distal end of the one or more facets.

17. The method of claim 16, further comprising:
disposing the thin film layer at the substantially planar surface of the distal end of one or more facets, and wherein the thin film layer includes a semi-reflective material.

18. The method of claim 13, further comprising:
implementing one or more optical components at least partially in alignment with the one or more facets, wherein the one or more optical components comprise at least one of an exit pupil expander or an output coupler.

19. The method of claim 13, further comprising:
implementing the one or more pupil replicators by varying a length of the substantially planar surface of two or more subsequent facets of the one or more facets.

20. A head mounted wearable device implementing the reflective waveguide of claim 13.
